(19) United States
(12) Patent Application Publication
(10) Pub. No.: US 2011/0314034 A1
(43) Pub. Date: Dec. 22, 2011

(54) CONCEPT-BASED DATA PROCESSING

(75) Inventors: Ram B. Adhikari, Bangalore (IN); Gerald B. Huff, Berkeley, CA (US)

(73) Assignee: INTUIT INC., Mountain View, CA (US)

(21) Appl. No.: 12/818,042

(22) Filed: Jun. 17, 2010

(51) Int. Cl. G06F 17/30

(52) U.S. Cl. 707/754; 707/E17.045

(57) ABSTRACT

The present embodiments provide a system that processes data. During operation, the system obtains, from a set of technical users, a set of concept definitions comprising filters against data in a data domain. Next, the system provides the concept definitions to a set of end users of the data. Finally, the system facilitates, for the end users, processing of the data by applying the concept definitions to the data.

### BACKGROUND

### Related Art

The present embodiments relate to techniques for processing data. More specifically, the present embodiments relate to an application-independent method and system for providing concept-based data processing and report generation to end users of data.

Data processing and the associated exchange of data are essential to many business and personal transactions. For example, small businesses may use accounting and/or inventory data to obtain and share reports regarding inventory sales, customer invoices, and/or cash flow. Similarly, healthcare providers may examine medical records to view patient information related to insurance providers, medical conditions, and/or office visits.

In addition, user interaction with data frequently involves the use of software applications. For example, a small business owner may use an accounting application to obtain and/or process data associated with customers, inventory, sales, and/or taxes. The small business owner may then share the reports with other users (e.g., business partners, accountants, etc.) by exporting the data to one or more files and attaching the files to an email addressed to the other users.

Such application-based data processing has a number of disadvantages. In particular, access to data is often limited to applications that are used to create and/or manipulate the data. For example, accounting data that is managed using an accounting application may only be accessed by an end user (e.g., small business owner) through the accounting application. Moreover, the end user may lack the ability to filter and/or make queries against the data in specific ways. For example, an accounting application may lack features that allow a small business owner to obtain data that meets specific criteria, such as top salespeople, products, and/or customers.

Conversely, business intelligence tools that enable direct access to and/or querying of stored data may require technical training and/or knowledge to use. In turn, such business intelligence tools may be unsuitable for end users who lack technical backgrounds and/or prefer simpler means for accessing data.

Hence, what is needed is a mechanism for reducing the complexity and overhead associated with application-specific data processing and use.

### SUMMARY

The present embodiments provide a system that processes data. During operation, the system obtains, from a set of technical users, a set of concept definitions comprising filters against data in a data domain. Next, the system provides the concept definitions to a set of end users of the data. Finally, the system facilitates, for the end users, processing of the data by applying the concept definitions to the data.

In some embodiments, the system also stores the concept definitions in a concept repository.

In some embodiments, the system also enables modification of the concept definitions in the concept repository by the technical users.

In some embodiments, the concept definitions are provided to the end users using at least one of an application, a plugin, and a website.

In some embodiments, providing the concept definitions to the end users involves at least one of displaying one or more concept descriptions from the concept definitions to the end users, and enabling searches of the concept definitions by the end users.

In some embodiments, facilitating processing of the data by the end users involves at least one of:
(i) retrieving data associated with the concept definitions for the end users;
(ii) modifying parameters associated with the concept definitions;
(iii) combining two or more concept definitions;
(iv) identifying relationships between the concept definitions; and
(v) generating reports from the data using the concept definitions.

In some embodiments, the data domain is associated with at least one of a data provider and a relational database.

In some embodiments, each of the concept definitions corresponds to an Extensible Markup Language (XML) document.

### BRIEF DESCRIPTION OF THE FIGURES

FIG. 1 shows a schematic of a system in accordance with an embodiment.

FIG. 2A shows an exemplary screenshot in accordance with an embodiment.

FIG. 2B shows an exemplary screenshot in accordance with an embodiment.

FIG. 3A shows an exemplary screenshot in accordance with an embodiment.

FIG. 3B shows an exemplary screenshot in accordance with an embodiment.

FIG. 3C shows an exemplary screenshot in accordance with an embodiment.

FIG. 4 shows a flowchart illustrating the processing of data in accordance with an embodiment.

FIG. 5 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

Embodiments provide a method and system for processing data. The data may be accessed and stored by end users through one or more applications. For example, accounting data for a small business may be stored, modified, and accessed through an accounting application. Along the same lines, medical records for patients of a healthcare provider may be managed through medical software.

More specifically, embodiments provide an application-independent method and system for providing concept-based data processing and report generation to end users of data. A technical-user interface may allow technical users to provide concept definitions containing filters against data in a data domain, such as a data provider (e.g., application) or a relational database. For example, each concept definition may correspond to an Extensible Markup Language (XML) document that includes information that may be used to create and execute a Structured Query Language (SQL) query in a relational database. An end-user interface may then provide the concept definitions to the end users, who may process the data by applying the concept definitions to the data. For example, the end users may retrieve data and/or generate reports using the concept definitions. Data processing may further be facilitated by modifying parameters associated with the concept definitions, combining (e.g., using database unions or joins) two or more concept definitions, and/or identifying relationships among the concept definitions.

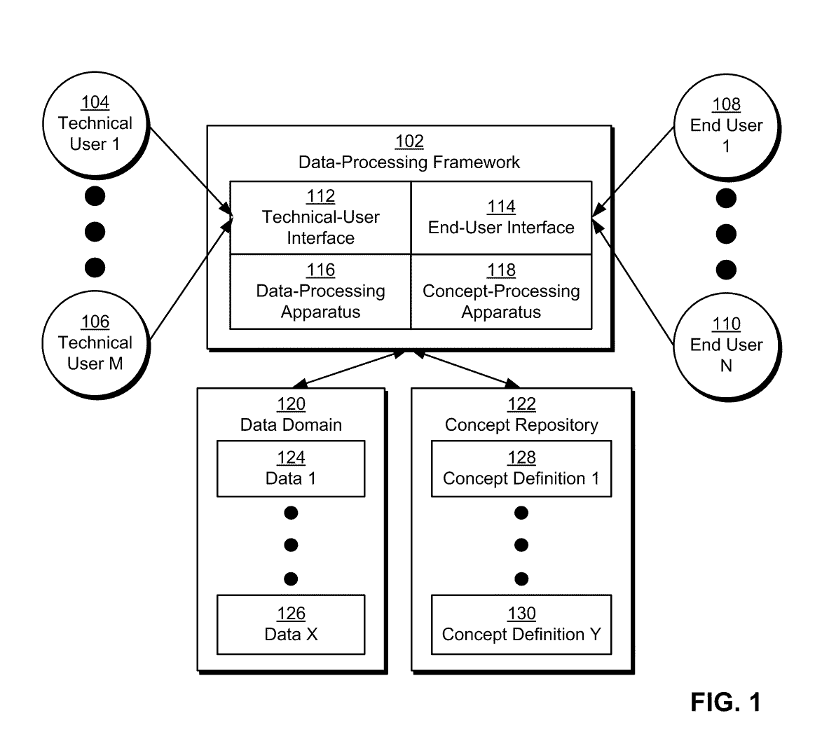

FIG. 1 shows a schematic of a system in accordance with an embodiment. In one or more embodiments, the system corresponds to a data-processing framework 102 that may be accessed by a set of technical users (e.g., technical user 1 104, technical user m 106) and a set of end users (e.g., end user 1 108, end user n 110). Data-processing framework 102 includes a technical-user interface 112, an end-user interface 114, a data-processing apparatus 116, and a concept-processing apparatus 118. Each of these components is described in further detail below.

In one or more embodiments, data-processing framework 102 facilitates processing of data (e.g., data 1 124, data x 126) in a data domain 120 by end users (e.g., end user 1 108, end user n 110) through collaboration and/or input from technical users (e.g., technical user 1 104, technical user m 106). Data domain 120 may correspond to a data provider (e.g., server, repository, etc.) and/or relational database. Each end user may access and manage the data through an application that includes an interface with the data provider and/or relational database. For example, a small business owner may create, modify, and/or delete accounting data for a small business using an accounting application, while a healthcare provider may manage medical records for patients using medical software.

However, the application may include limited functionality for organizing the data, filtering the data, and/or generating reports from the data. For example, an accounting application may provide invoices and account totals for a business to a small-business owner but may not allow the small-business owner to easily sort or filter accounting data using concepts such as “best customers” or “customers with past-due invoices.” On the other hand, business intelligence tools that allow users to directly access data in data domain 120 may be too complex and/or time-consuming for most end users to adopt.

In one or more embodiments, data-processing framework 102 allows the end users to perform concept-based filtering of data in data domain 120. As mentioned above, the end users may receive assistance from technical users through data-processing framework 102. As a result, data-processing framework 102 may provide interfaces for both the end users and technical users. As shown in FIG. 1, technical-user interface 112 may enable the technical users to access data-processing framework 102, while end-user interface 114 may allow the end users to access data-processing framework 102.

Technical-user interface 112 may allow the technical users to create a set of concept definitions (e.g., concept definition 1 128, concept definition y 130). Each concept definition may include one or more filters against data in data domain 120. In one or more embodiments, a concept definition may correspond to an Extensible Markup Language (XML) document that includes information that may be used to create a Structured Query Language (SQL) query for a relational database. In other words, concept definitions may correspond to mappings between high-level concepts associated with data domain 120 and low-level storage mechanisms and/or structures containing the data. For example, a concept definition related to medical records may map the concept of “Patients Above the Age of 65” to a database query that retrieves medical records from a database based on the value of an “Age” or “Date of Birth” attribute in each medical record.

Each concept definition may additionally include a name, a namespace, a concept description, a version, one or more parameters, and/or other elements. For example, the following XML schema may specify the structure and content of valid concept definitions used by data-processing framework 102:

<?xml version=“1.0” encoding=“utf-8”?>
<xs:schema targetNamespace=“http://concept2.5.intuit.com/2009”

elementFormDefault=“qualified”
xmlns=“http://concept2.5.intuit.com/2009”
xmlns:mstns=“http://concept2.5.intuit.com/2009”
xmlns:xs=“http://www.w3.org/2001/XMLSchema”>

<xs:element name=“ConceptData”>

<xs:complexType>

<xs:sequence>

<xs:element ref=“Identity” maxOccurs=“1” minOccurs=“1” />
<xs:element ref=“ParamInstance” minOccurs=“0”

maxOccurs=“unbounded” />

<xs:element name=“Fields” type=“xs:string” minOccurs=“0”

maxOccurs=“1” />

<xs:element name=“Filter” type=“xs:string” minOccurs=“0”

maxOccurs=“1” />

<xs:element name=“GroupBy” type=“xs:string” maxOccurs=“1”

minOccurs=“0” />

<xs:element name=“OrderBy” type=“xs:string” minOccurs=“0”

maxOccurs=“1” />

</xs:sequence>

</xs:complexType>

</xs:element>
<xs:element name=“Identity”>

<xs:complexType>

<xs:sequence>

<xs:element name=“Name” type=“xs:string” maxOccurs=“1”

minOccurs=“1” />

<xs:element name=“Group” type=“xs:string” maxOccurs=“1”

minOccurs=“1” />

<xs:element name=“Version” type=“xs:string” maxOccurs=“1”

minOccurs=“1” />

</xs:sequence>

<xs:complexType>

</xs:element>
<xs:element name=“ParamInstance”>

<xs:complexType>

<xs:sequence>

<xs:element name=“Name” type=“xs:string” minOccurs=“1”

maxOccurs=“1” />

<xs:element name=“Value” type=“xs:anyType” minOccurs=“1”

maxOccurs=“1” />

</xs:sequence>

</xs:complexType>

</xs:element>
<xs:element name=“Union”>

<xs:complexType>

<xs:sequence>

<xs:element ref=“ComplexConceptData” minOccurs=“2”

maxOccurs=“unbounded” />

</xs:sequence>

</xs:complexType>

</xs:element>
<xs:element name=“Join”>

<xs:complexType>

<xs:sequence>

<xs:element ref=“ComplexConceptData” minOccurs=“1”

maxOccurs=“1” />

<xs:element ref=“ComplexConceptData” minOccurs=“1”

maxOccurs=“1” />

<xs:element name=“JoinCondition” type=“xs:string”

maxOccurs=“1” minOccurs=“1” />

</xs:sequence>

</xs:complexType>

</xs:element>
<xs:element name=“ComplexConceptData”>

<xs:complexType>

<xs:sequence>

<xs:choice>

<xs:element ref=“ConceptData” />
<xs:element ref=“Union” />
<xs:element ref=“Join” />

</xs:choice>

</xs:sequence>

</xs:complexType>

</xs:element>
<xs:element name=“Concept”>

<xs:complexType>

<xs:sequence>

<xs:element ref=“Identity” minOccurs=“1” maxOccurs=“1” />
<xs:element name=“DisplayName” type=“xs:string”

minOccurs=“0” maxOccurs=“1” />

<xs:element name=“Description” type=“xs:string”

minOccurs=“0” maxOccurs=“1” />

<xs:element ref=“Parameters” minOccurs=“0”

maxOccurs=“1” />

<xs:element name=“CreatedBy” type=“xs:string” />
<xs:element name=“DateOfCreation” type=“xs:dateTime” />
<xs:element ref=“OfKind” minOccurs=“0” maxOccurs=“1” />
<xs:element ref=“ComplexConceptData” minOccurs=“0”

maxOccurs=“1” />

</xs:sequence>

</xs:complexType>

</xs:element>
<xs:element name=“OfKind”>

<xs:complexType>

<xs:sequence>

<xs:element ref=“Identity” maxOccurs=“1” minOccurs=“1” />

</xs:sequence>

</xs:complexType>

</xs:element>
<xs:element name=“Parameter”>

<xs:complexType>

<xs:sequence>

<xs:element name=“Name” type=“xs:string” maxOccurs=“1”

minOccurs=“1” />

<xs:element name=“Type” type=“xs:string” maxOccurs=“1”

minOccurs=“1” />

<xs:element name=“DefaultValue” type=“xs:anyType”

maxOccurs=“1” minOccurs=“0” />

</xs:sequence>

</xs:complexType>

</xs:element>
<xs:element name=“Parameters”>

<xs:complexType>

<xs:sequence>

<xs:element ref=“Parameter” maxOccurs=“unbounded”

minOccurs=“0” />

</xs:sequence>

</xs:complexType>

</xs:element>

</xs:schema>

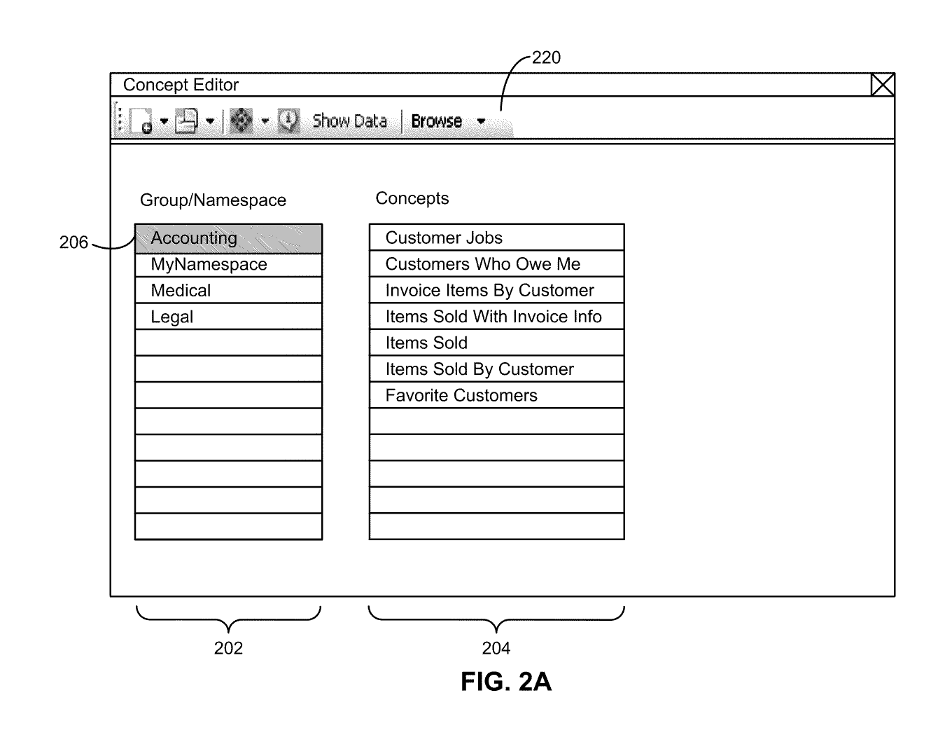

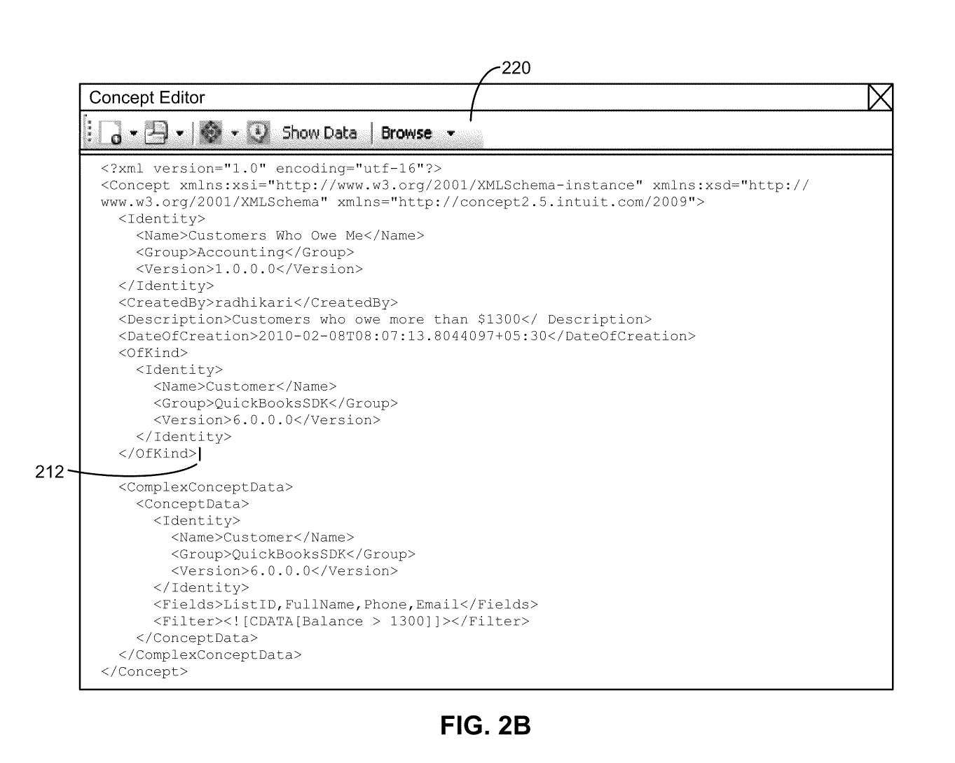

XML elements and concept definitions associated with the XML schema above are discussed below with respect to FIG. 2B.

Once a concept definition is created by a technical user through technical-user interface 112, concept-processing apparatus 118 may validate the concept definition and store the concept definition in a concept repository 122. As discussed below with respect to FIGS. 2A-2B, the technical user and/or other technical users may also use technical-user interface 112 to subsequently modify and/or delete the concept definition. For example, concept-processing apparatus 118 may verify the structure of a newly created concept definition and run tests on the concept definition to ensure that the concept definition accurately retrieves data from data domain 120. Concept-processing apparatus 118 may also store the concept definition in a relational database for subsequent modification by the technical users through technical-user interface 112.

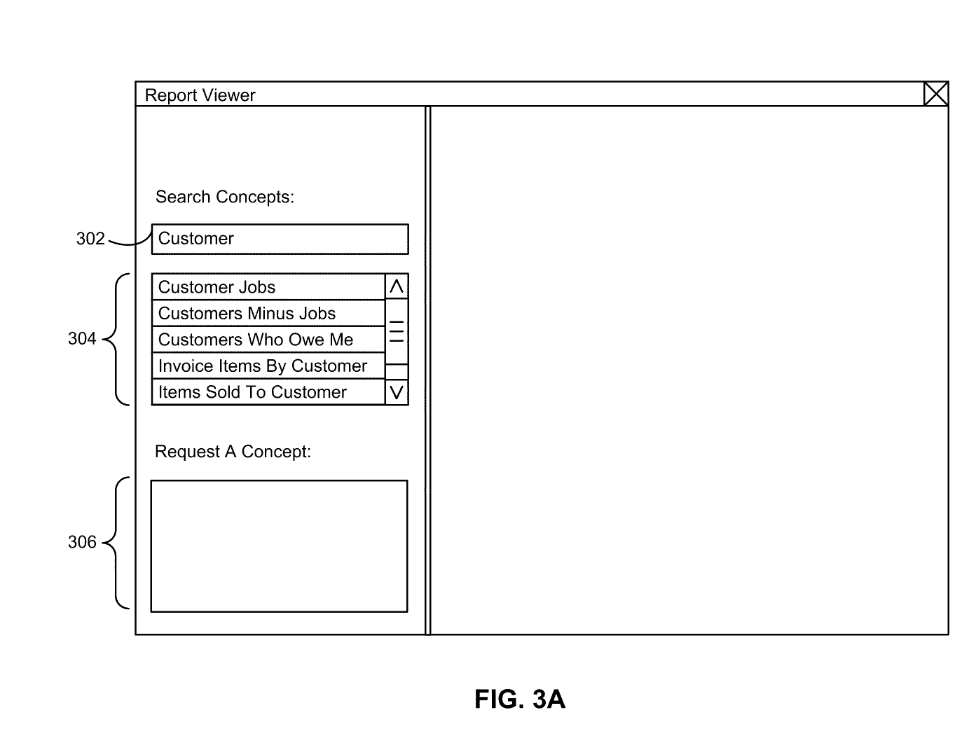

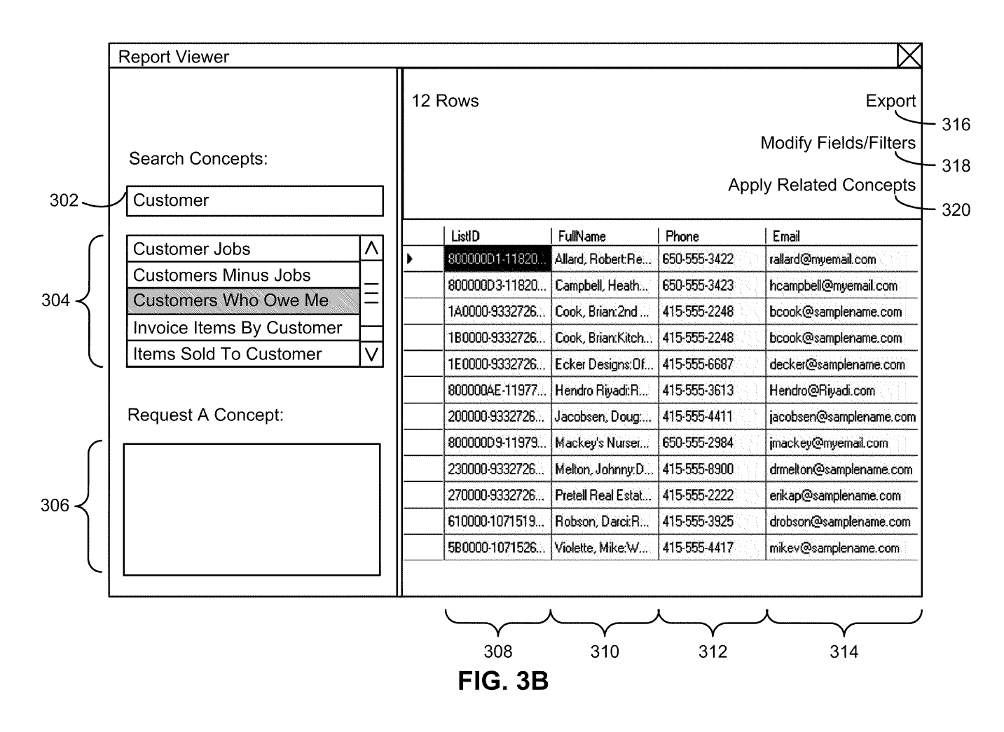

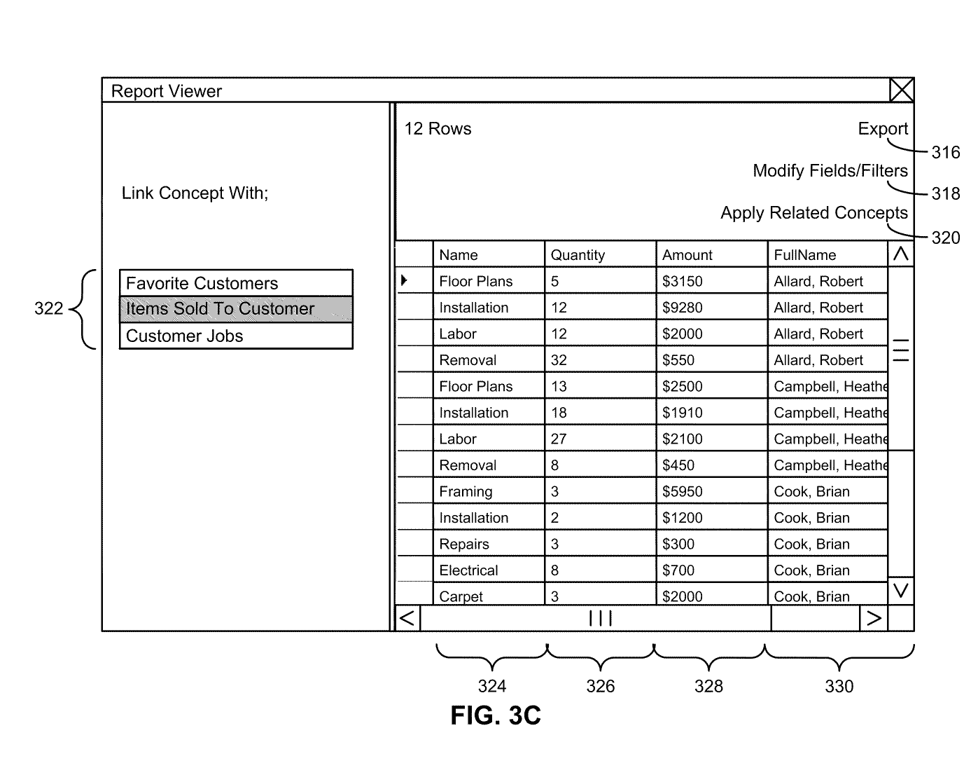

End-user interface 114 may then provide the concept definitions in concept repository 122 to the end users. For example, end-user interface 114 may display one or more concept descriptions from the concept definitions to the end users and/or enable searches of the concept definitions by the end users. End-user interface 114 may also obtain selections of one or more concept definitions by the end users for application to data in data domain 120. End-user interface 114 may further allow the end users to request concept definitions from the technical users if existing concept definitions in concept repository 122 do not suit the end users' needs and/or preferences. End-user interface 114 is discussed in further detail below with respect to FIGS. 3A-3C.

Data-processing apparatus 116 may then apply the selected concept definitions to the data. More specifically, data-processing apparatus 116 may use an interface with data domain 120 to retrieve data associated with the concept definitions from data domain 120. For example, data-processing apparatus 116 may process data for an end user by creating a SQL query using a concept definition selected by the end user and executing the SQL query through an interface with a relational database containing the data. Data-processing apparatus 116 may also generate reports from the data. For example, data-processing apparatus 116 may generate a report containing accounting data for a small business owner by formatting the accounting data into a spreadsheet or Portable Document Format (PDF) document. The small business owner may then share the accounting data with an accountant, business partner, and/or other end user by attaching the report in an email addressed to the other end user.

In one or more embodiments, concept-processing apparatus 118 includes functionality to further facilitate processing of data for the end users by analyzing and/or indexing concept definitions in concept repository 122. First, concept-processing apparatus 118 may create searchable indexes of the elements of the concept definitions. End-user interface 114 may use the indexes to perform searches of the concept definitions based on search terms provided by the end users.

Next, concept-processing apparatus 118 may identify relationships among the concept definitions. For example, concept-processing apparatus 118 may identify concept definitions that retrieve the same attribute from a database table. Concept-processing apparatus 118 may also identify groups of concept definitions that provide similar and/or related filters against data in data domain 120.

Finally, concept-processing apparatus 118 may annotate the concept definitions using the analyzed relationships. For example, concept-processing apparatus 118 may store the relationships and/or common attributes found during analysis of the concept definitions as metadata in the concept descriptions and/or in other files within concept repository 122. The annotations may then be used by data-processing apparatus 116 to combine two or more concept definitions containing related attributes and/or structures (e.g., using database joins and/or unions), thus effectively allowing the end users to process data using a series of concept definitions. End-user interface 114 may also use the annotations to recommend related and/or suitable concept definitions to an end user upon receiving a selection of a concept definition from the end user.

Those skilled in the art will appreciate that data-processing framework 102 may be implemented in a variety of ways. For example, data-processing framework 102 may be implemented using a client-server architecture, in which data-processing framework 102, data domain 120, and/or concept repository 122 are provided by one or more servers. Moreover, technical-user interface 112 and end-user interface 114 may be provided by an application, a plugin, and/or a website. For example, technical-user interface 112 and end-user interface 114 may correspond to graphical user interfaces (GUIs) of applications that include functionality to communicate with other parts of data-processing framework 102, or technical-user interface 112 and end-user interface 114 may facilitate interaction and collaboration among the technical and end users through a web-based user interface (e.g., a web browser).

FIG. 2A shows an exemplary screenshot in accordance with an embodiment. More specifically, FIG. 2A shows a screenshot of a technical-user interface, such as technical-user interface 112 of FIG. 1. As discussed above, the technical user interface may be provided by an application, plugin, and/or website. For example, the screenshot of FIG. 2A may be provided by a website that is loaded by a web browser from a Uniform Resource Locator (URL). On the other hand, the screenshot may form a part of a GUI for an application that is locally installed on a computer system. Some or all of the technical-user interface may also be generated using a plugin for a web browser and/or application.

As shown in FIG. 2A, the technical-user interface includes a toolbar 220 that may allow a technical user to perform tasks related to the creation and modification of concept definitions. For example, toolbar 220 may include buttons, drop-down menus, and/or other user interface elements that allow the technical user to create new concept definitions, browse or open existing concept definitions, search for words and phrases within the concept definitions, communicate with end users, and/or use data to verify the correctness of each concept definition.

Below toolbar 220, the technical-user interface includes two lists 202-204 of selectable user interface elements. List 202 may correspond to a list of namespaces (e.g., groups, categories, etc.) associated with the technical user and/or data, and list 204 may contain concept definitions associated with one or more selected namespaces in list 202. For example, namespaces may represent data domains, databases, development stages, and/or other groups or categories associated with the technical user and/or data. To select a namespace in list 202, the technical user may use a cursor, keyboard shortcut, and/or other input mechanism provided by the technical-user interface.

List 202 contains four elements (e.g., “Accounting,” “MyNamespace,” “Medical,” “Legal”), with a user selection 206 of the first element. Consequently, concept definitions in list 204 may correspond to accounting-related concepts such as “Customer Jobs,” “Customers Who Owe Me,” “Invoice Items By Customer,” “Items Sold With Invoice Info,” “Items Sold,” “Items Sold By Customer,” and/or “Favorite Customers.” The user may then select an element in list 204 to view and/or modify the corresponding concept definition, or the user may create a new concept definition by selecting an icon in toolbar 220, inputting a keyboard shortcut, and/or otherwise interacting with the technical-user interface.

FIG. 2B shows an exemplary screenshot in accordance with an embodiment. The screenshot of FIG. 2B may correspond to the technical-user interface of FIG. 2A after a concept definition is selected from list 204. As shown in FIG. 2B, the concept definition corresponds to an XML document that conforms to the XML schema shown above. The technical user may modify the concept definition within the technical-user interface using a cursor 212, keyboard, and/or other input mechanism. In other words, the screenshot of FIG. 2B may correspond to a text editor such as an XML editor.

The technical-user interface may also include functionality to enable graphical editing of the concept definition. For example, the technical-user interface may generate a set of cells and/or form fields corresponding to XML elements in the concept definition. The technical user may then create and/or edit the concept definition by filling in the cells and/or form fields with text corresponding to the content of the XML elements.

At the top of the XML document, the technical user may identify the concept definition using the “Identity” element and child elements “Name,” “Group,” and “Version.” In particular, the concept definition may include a name of “Customers Who Owe Me” and a group (e.g., namespace) of “Accounting,” indicating that the concept definition corresponds to the second element of list 204 in FIG. 2A. The concept definition may also include a version of “1.0.0.0” to enable subsequent tracking of changes to the concept definition over time. For example, newer versions (e.g., “1.0.0.1,” “2.0.0.0,” etc.) of the concept definition may be created in response to changes in accounting definitions and/or contexts associated with the concept of “Customers Who Owe Me.”

In addition, the XML document may include elements containing basic information about the concept definition. The “CreatedBy” element may identify the creator (e.g., “radhikari”) of the concept description, the “Description” element may include a description (e.g., “Customers who owe more than $1300”) of the concept definition, and the “DateOfCreation” element may include a timestamp corresponding to the date and time at which the concept definition was created (e.g., “2010-02-08T08:07:13.8044097+05:30”).

Next, the “OfKind” element may include another “Identity” element with the same child elements that reference another concept definition. The reference may indicate that the concept definition is related to and/or is a type of the other concept. For example, the “OfKind” element may indicate that the concept definition is related to and/or a type of concept definition with a name of “Customer,” a namespace/group of “QuickBooksSDK,” and a version of “6.0.0.0.”

The “ComplexConceptData” element may include child elements that describe the filters and/or data (e.g., “ConceptData”) associated with the concept definition. Within the “ConceptData” child element, a third “Identity” element describes a name (e.g., “Customer”), group/namespace (e.g., “QuickBooksSDK”), and version (e.g., “6.0.0.0”) of the data to be processed using the concept definition. In other words, the identity information nested in the “ConceptData” element may be used to locate the data that is relevant to the concept definition.

The “Fields” element may specify the type(s) of data to be retrieved using the concept definition, while the “Filter” element may filter the retrieved data. For example, the concept definition may enable the display of the “ListId,” “FullName,” “Phone,” and “Email” columns from a database table that is located using the identity information for the “ConceptData” element, while the “Filter” element may be used to display only the results containing a “Balance” attribute of greater than 1300.

Alternatively, the concept definition may allow the end user to specify a parameter corresponding to the value of the “Balance” attribute above which results are returned. For example, the concept definition may include the following elements nested within the “Concept” element:

<Parameters>

<Parameter>

<Name>Balance</Name>
<Type>Number</Type>
<DefaultValue>1300</DefaultValue>

</Parameter>

</Parameters>

To provide the same functionality as the “Filter” element, the “Parameter” element may specify a name “Balance,” a type of “Number,” and a default value of “1300.” However, the “Parameter” element may be used by an end-user interface to filter the data using a user-provided value for “Balance” in lieu of 1300.

The concept definition may also be combined with other concept definitions. As mentioned previously, the concept definition may be analyzed for relationships and/or similarities to other concept definitions by a concept-processing apparatus, such as concept-processing apparatus 118 of FIG. 1. If a relationship is found, the concept definition may be annotated with a “Union” or “Join” element nested within the “ComplexConceptData” element to enable the concept definition to be combined with other concept definitions using a database union or join. Combining concept definitions is discussed below in further detail with respect to FIG. 3C.

FIG. 3A shows an exemplary screenshot in accordance with an embodiment. In particular, FIG. 3A shows a screenshot of an end-user interface, such as end-user interface 114 of FIG. 1. The end-user interface may allow an end user of data to process data using one or more concept definitions associated with the data.

First, the end-user interface may include a field 302 that allows the end user to search for concept definitions. The end-user interface may scan searchable indexes containing the names, concept descriptions, and/or other elements of the concept definitions for words or phrases that match the search term(s) in field 302 (e.g., “Customer”). The end-user interface may then display the names of the matching concept definitions in a list 304 (e.g., “Customer Jobs,” “Customers Minus Jobs,” “Customers Who Owe Me,” “Invoice Items By Customer,” “Items Sold To Customer”).

The user may apply one or more concept definitions from list 304 to the data by selecting the concept definition(s) using a cursor, keyboard, and/or other input mechanism. Alternatively, the user may fill in a field 306 to request a concept (e.g., “Top Customers,” “Top-Selling Items,” etc.) that is not available in list 304 from one or more technical users. In other words, the end-user interface may enable communication and collaboration between the end user and one or more technical users associated with the creation of the concept definitions.

FIG. 3B shows an exemplary screenshot in accordance with an embodiment. The screenshot of FIG. 3B may correspond to the end-user interface of FIG. 3A after the third element of list 304 (e.g., “Customers Who Owe Me”) is selected by the end user. In response, the end-user interface may apply the corresponding concept definition to the end user's data and display the results in four columns 308-314. For example, columns 308-314 may show data that is retrieved by executing a database query created from the concept definition shown in FIG. 2B. In other words, column 308 may contain “ListID” attribute values, column 310 may contain “FullName” attribute values, column 312 may contain “Phone” attribute values, and column 314 may contain “Email” attribute values of database entries from the “Customer” table whose “Balance” attribute is greater than 1300.

The end user may select an element 316 (e.g., “Export”) within the end-user interface to generate a report using the data in columns 308-314. The report may be formatted as a spreadsheet, PDF document, and/or other file format that enables sharing of the data with other users. For example, the end user may attach the report in an email to an assistant with instructions to contact the customers listed in columns 308-314 with payment reminders.

The end user may also select an element 318 (e.g., “Modify Fields/Filters”) to modify the fields shown in columns 308-314 and/or the filter(s) used to retrieve the data. For example, the selection of element 318 may trigger a pop-up containing attribute names (e.g., database columns) that may be selected or deselected by the end user. A selected attribute name may be shown in the results matching the concept description, while a deselected attribute may be omitted from the results. The pop-up may also include a form field that allows the user to specify additional filters to be applied to the data and/or modify the filter (e.g., the minimum value of the “Balance” attribute) from the concept description.

Finally, the user may select an element 320 (e.g., “Apply Related Concepts”) to combine the concept definition with one or more related concept definitions. As discussed above, the related concept definitions may be used to retrieve one or more of the same attributes as the concept definition selected in list 304. The related concept definitions may thus be combined with the results of the selected concept definition (e.g., using database unions or joins) to further facilitate processing of the data by the end user.

FIG. 3C shows an exemplary screenshot in accordance with an embodiment. More specifically, FIG. 3C shows the end-user interface of FIG. 3B after the user selects element 320. A list 322 of related concept definitions is shown on the left side of the end-user interface, and the second element (e.g., “Items Sold To Customer”) is selected.

The data shown in the end-user interface is also updated to reflect the combined application of the “Customers Who Owe Me” concept definition with the “Items Sold To Customer” concept definition. For example, the end-user interface may include four new columns 324-330 containing data corresponding to items sold to customers who owe more than a certain amount of money to the end user. Column 324 may contain attribute values representing the names of items bought, column 326 may contain attribute values representing the quantity of each item bought, column 328 may contain attribute values representing the prices of the items, and column 330 may contain attribute values representing the customers' full names. Additional columns of data may be viewed by dragging the horizontal scrollbar at the bottom of columns 324-330 and/or adding columns to the retrieved data using element 318.

The end user may continue using the end-user interface to process and/or customize data. For example, the end user may apply additional concept definitions, add or remove columns, and/or add or remove filters to include or omit information from the retrieved data. Once the data is customized and/or organized in accordance with the end user's preferences, the end user may generate a report from the data to view and/or share the data outside the end-user interface.

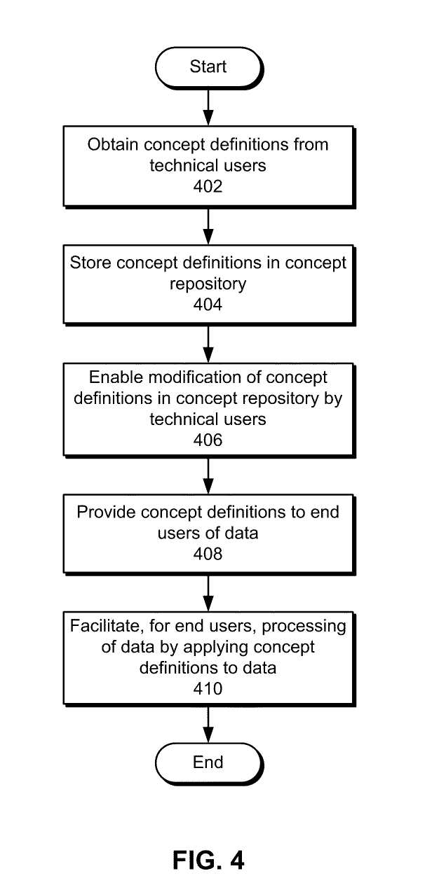

FIG. 4 shows a flowchart illustrating the processing of data in accordance with an embodiment. In one or more embodiments, one or more of the steps may be omitted, repeated, and/or performed in a different order. Accordingly, the specific arrangement of steps shown in FIG. 4 should not be construed as limiting the scope of the embodiments.

First, a set of concept definitions is obtained from a set of technical users (operation 402). Each concept definition may provide a filter against data in a data domain, such as an application, data provider, and/or relational database. Next, the concept definitions are stored in a concept repository (operation 404), and modification of the concept definitions by the technical users is enabled (operation 406). For example, the concept definitions may be created, modified, and/or deleted by the technical users using a technical-user interface.

The concept definitions are also provided to a set of end users of the data (operation 408). For example, the concept definitions may be provided by an end-user interface that displays one or more concept descriptions from the concept definitions to the end users and/or enables browsing or searching of the concept definitions by the end users. The technical-user interface and end-user interface may be graphical or web-based and may be provided by an application, plugin, and/or website.

Finally, processing of the data by the end users is facilitated by applying the concept definitions to the data (operation 410). In particular, one or more concept definitions may be selected by the end users through the end-user interface. Data associated with the selected concept definitions may then be retrieved for the end users, and/or reports may be generated from the data. Data processing may further be facilitated by modifying parameters associated with the concept definitions, combining two or more concept definitions, and/or identifying relationships between the concept definitions.

Consequently, the technical-user interface and end-user interface enable the technical users to collaborate and interact with the end users. In turn, the end users may use concept definitions created by the technical users to apply high-level concepts to data processing in an application-independent and non-technical manner.

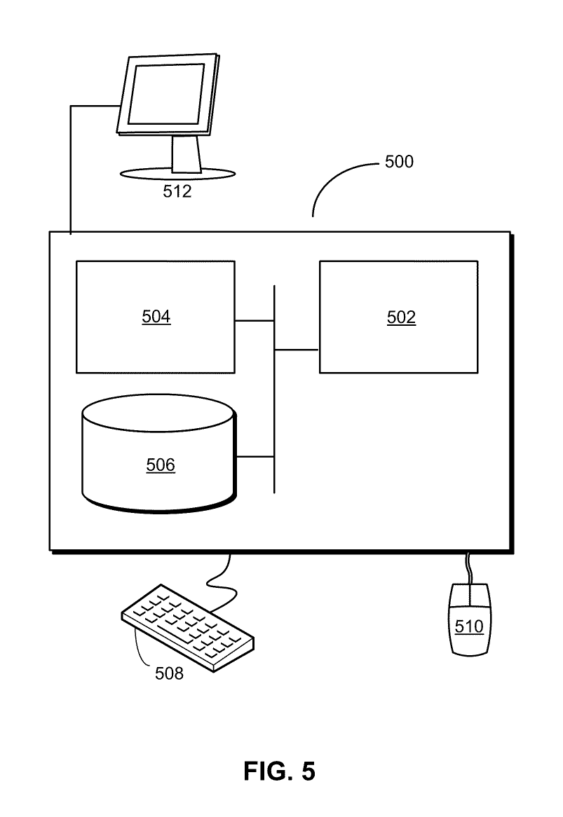

FIG. 5 shows a computer system 500 in accordance with an embodiment. Computer system 500 may correspond to an apparatus that includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include a technical-user interface that obtains, from a set of technical users, a set of concept definitions comprising filters against data in a data domain, as well as an end-user interface that provides the concept definitions to a set of end users of the data. The system may also include a data-processing apparatus that facilitates, for the end users, processing of the data by applying the concept definitions to the data. Finally, the system may include a concept-processing apparatus that stores the concept definitions in a concept repository, joins two or more concept definitions, and/or identifies relationships between the concept definitions.

In addition, one or more components of computer system 500 may be remotely located and connected to the other components over a network. Portions of the present embodiments (e.g., technical-user interface, concept repository, end-user interface, data-processing apparatus, etc.) may also be located on different nodes of a distributed system that implements the embodiments. For example, the present embodiments may be implemented using a cloud computing system that enables application-independent, concept-based data processing and report generation for the end users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A system for processing data, comprising:
a technical-user interface configured to obtain, from a set of technical users, a set of concept definitions comprising filters against data in a data domain;
an end-user interface configured to provide the concept definitions to a set of end users of the data; and
a data-processing apparatus configured to facilitate, for the end users, processing of the data by applying the concept definitions to the data.

2. The system of claim 1, further comprising:
a concept-processing apparatus configured to store the concept definitions in a concept repository.

3. The system of claim 2, wherein the concept-processing apparatus is further configured to:
identify relationships between the concept definitions; and
annotate the concept definitions in the concept repository based on the relationships.

4. The system of claim 2, wherein the technical-user interface is further configured to enable modification of the concept definitions in the concept repository by the technical users.

5. The system of claim 1, wherein the technical-user interface and the end-user interface are provided by at least one of an application, a plugin, and a website.

6. The system of claim 1, wherein providing the concept definitions to the end users involves at least one of:
displaying one or more concept descriptions from the concept definitions to the end users; and
enabling searches of the concept definitions by the end users.

7. The system of claim 1, wherein facilitating processing of the data by the end users involves at least one of:
retrieving data associated with the concept definitions for the end users;
combining two or more concept definitions;
modifying parameters associated with the concept definitions; and
generating reports from the data using the concept definitions.

8. The system of claim 1, wherein the data domain is associated with at least one of a data provider and a relational database.

9. A computer-implemented method for processing data, comprising:
obtaining, from a set of technical users, a set of concept definitions comprising filters against data in a data domain;
providing the concept definitions to a set of end users of the data; and
facilitating, for the end users, processing of the data by applying the concept definitions to the data.

10. The computer-implemented method of claim 9, further comprising:
storing the concept definitions in a concept repository.

11. The computer-implemented method of claim 10, further comprising:
enabling modification of the concept definitions in the concept repository by the technical users.

12. The computer-implemented method of claim 9, wherein the concept definitions are provided to the end users using at least one of an application, a plugin, and a website.

13. The computer-implemented method of claim 9, wherein providing the concept definitions to the end users involves at least one of:
displaying one or more concept descriptions from the concept definitions to the end users; and
enabling searches of the concept definitions by the end users.

14. The computer-implemented method of claim 9, wherein facilitating processing of the data by the end users involves at least one of:
retrieving data associated with the concept definitions for the end users;
combining two or more concept definitions;
identifying relationships between the concept definitions;
modifying parameters associated with the concept definitions; and
generating reports from the data using the concept definitions.

15. The computer-implemented method of claim 9, wherein the data domain is associated with at least one of a data provider and a relational database.

16. The computer-implemented method of claim 9, wherein each of the concept definitions corresponds to an Extensible Markup Language (XML) document.

17. A computer-readable storage medium storing instructions that when executed by a computer cause the computer to perform a method for processing data, the method comprising:
obtaining, from a set of technical users, a set of concept definitions comprising filters against data in a data domain;
providing the concept definitions to a set of end users of the data; and
facilitating, for the end users, processing of the data by applying the concept definitions to the data.

18. The computer-readable storage medium of claim 17, the method further comprising:
storing the concept definitions in a concept repository.

19. The computer-readable storage medium of claim 18, the method further comprising:
enabling modification of the concept definitions in the concept repository by the technical users.

20. The computer-readable storage medium of claim 17, wherein the concept definitions are provided to the end users using at least one of an application, a plugin, and a website.

21. The computer-readable storage medium of claim 17, wherein providing the concept definitions to the end users involves at least one of:
displaying one or more concept descriptions from the concept definitions to the end users; and
enabling searches of the concept definitions by the end users.

22. The computer-readable storage medium of claim 17, wherein facilitating processing of the data by the end users involves at least one of:
retrieving data associated with the concept definitions for the end users;
combining two or more concept definitions;
identifying relationships between the concept definitions;
modifying parameters associated with the concept definitions; and
generating reports from the data using the concept definitions.

23. The computer-readable storage medium of claim 17, wherein the data domain is associated with at least one of a data provider and a relational database.
